(19) United States
(12) Patent Application Publication
(10) Pub. No.: US 2013/0064522 A1
(43) Pub. Date: Mar. 14, 2013

(54) EVENT-BASED VIDEO FILE FORMAT

(71) Applicant: Georges TOUMA, Gatineau (CA)

(72) Inventor: Georges TOUMA, Gatineau (CA)

(21) Appl. No.: 13/228,702

(22) Filed: Sep. 9, 2011

(51) Int. Cl. H04N 9/80

(52) U.S. Cl. 386/248; 386/239; 386/E05.003

(57) ABSTRACT

There is described a method and system for recording, transmitting, and playing videos of an event-based format. Instead of providing a representation of each frame in a video as a complete image with brightness and color information for each pixel composing the image, each frame of a video is represented using a minimal data set that corresponds to an event that has taken place during the frame. Events are detected and recorded and the video may then be reconstructed by identifying actions that are triggered by the recorded events and executing the actions accordingly. Actions are identified by matching an event and an event coordinate, considering the objects and/or shapes present in a frame at the event coordinate and determining the consequences of the event on the objects/shapes.

### CROSS-REFERENCE TO RELATED APPLICATIONS

This is the first application filed for the present invention.

### TECHNICAL FIELD

The present invention relates to the field of image file formats and particularly video file formats.

### BACKGROUND OF THE ART

Image file formats are standardized means of organizing and storing digital images. Image files are composed of either pixels, vector data, or a combination of the two. Whatever the format, the files are rasterized to pixels when displayed on most graphic displays. The pixels that constitute an image are ordered as a grid (columns and rows), and each pixel consists of numbers representing magnitudes of brightness and color.

Image file sizes are typically expressed as a number of bytes and increase with the number of pixels composing an image, and the color depth of the pixels. The greater the number of rows and columns, the greater the image resolution, and the larger the file. Also, each pixel of an image increases in size when its color depth increases. For example, an 8-bit pixel (1 byte) stores 256 colors, a 24-bit pixel (3 bytes) stores 16 million colors.

Video files are essentially a series of images, each image representing a frame of the video. The greater the resolution of the images, the larger the size of the video file and the greater the bandwidth required to transfer the video file over a network.

There is a need to produce video files with high resolution that require lower bandwidth for transmission over a network.

### SUMMARY

There is described a method and system for recording, transmitting, and playing videos of an event-based format. Instead of providing a representation of each frame in a video as a complete image with brightness and color information for each pixel composing the image, each frame of a video is represented using a minimal data set that corresponds to an event that has taken place during the frame. Events are detected and recorded and the video may then be reconstructed by identifying actions that are triggered by the recorded events and executing the actions accordingly. Actions are identified by matching an event and an event coordinate, considering the objects and/or shapes present in a frame at the event coordinate and determining the consequences of the event on the objects/shapes.

The event-based video files may be stored locally on a first communication device for playback at a later time. They may also be stored remotely for retrieval and playback by the first communication device or a second communication device at a later time. In addition, the event-based video files may be transmitted from the first communication device to the second communication device for playback on the second communication device via any type of communications network capable of sending text files, including those having low bandwidth capabilities. The event-based video files are significantly reduced in size compared to traditional video files and therefore require less bandwidth for transmission. The smaller size is due to the smaller amount of information required to describe a single frame, as well as the lower number of frames for a video. The number of frames is dependent on the number of events occurring during video recordal, instead of being dependent on the length of time of the video.

In accordance with a first broad aspect, there is provided a method for recording an event-based video, the method comprising: detecting events from a set of user inputs, the events corresponding to input commands received from an input device and comprising an event description and an event coordinate representative of a position at which an event occurs; associating a time parameter to each detected event, the time parameter corresponding to a time span between detected events; and creating a text file with a plurality of frame descriptions, each one of the frame descriptions corresponding to instructions for generating a frame of the video and comprising at least one detected event and an associated time parameter, each event being convertible to an action triggered by a given event at a given event coordinate and applied to a given object present at the given event coordinate.

In accordance with another broad aspect, there is provided a method for playing an event-based video, the method comprising: receiving a text file having a plurality of frame descriptions therein, each one of the frame descriptions corresponding to instructions for generating a frame of the video and comprising at least one event and an associated time parameter, the event corresponding to an input command received from an input device and comprising an event description and an event coordinate representative of a position at which the event occurs, the time parameter representing a time span between subsequent events; extracting from each frame description the event and associated time parameter; converting the event to an action triggered by a given event at a given event coordinate and applied to a given object present at the given event coordinate; and applying the action to a previous image to generate a new image and thereby provide a subsequent frame in the video.

In accordance with another broad aspect, there is provided a method for recording and playing event-based videos. While recording, the method comprises detecting events from a set of user inputs, the events corresponding to input commands received from an input device and comprising an event description and an event coordinate representative of a position at which an event occurs; associating a time parameter to each detected event, the time parameter corresponding to a time span between detected events; and creating and storing a text file with a plurality of frame descriptions, each one of the frame descriptions corresponding to instructions for generating a frame of the video and comprising at least one detected event and an associated time parameter. To play the video, the method comprises retrieving the text file with the plurality of frame descriptions; extracting from each frame description the event and associated time parameter; converting the event to an action triggered by a given event at a given event coordinate and applied to a given object present at the given event coordinate; and applying the action to a previous image to generate a new image and thereby provide a subsequent frame in the video.

In accordance with yet another broad aspect, there is provided an event-based video recorder comprising: an event detection module adapted for detecting events from a set of user inputs, the events corresponding to input commands received from an input device and comprising an event description and an event coordinate representative of a position at which an event occurs; a time recorder module for recording and associating a time parameter to each detected event, the time parameter corresponding to a time span between detected events; and a text file creator adapted for creating a text file with a plurality of frame descriptions, each one of the frame descriptions corresponding to instructions for generating a frame of a video and comprising at least one detected event and an associated time parameter, each event being convertible to an action triggered by a given event at a given event coordinate and applied to a given object present at the given event coordinate.

In accordance with another broad aspect, there is provided an event-based video player comprising: a frame extraction module adapted for receiving a text file having a plurality of frame descriptions therein, each one of the frame descriptions corresponding to instructions for generating a frame of a video and comprising at least one event and an associated time parameter, the event corresponding to an input command received from an input device and comprising an event description and an event coordinate representative of a position at which the event occurs, the time parameter representing a time span between subsequent events, and extracting from each frame description the event and associated time parameter; and an image generator adapted for converting the event to an action triggered by a given event at a given event coordinate and applied to a given object present at the given event coordinate, and applying the action to a previous image to generate a new image and thereby provide a subsequent frame in the video.

In accordance with yet another broad aspect, there is provided an event based video recorder/player. A recording module comprises an event detection module adapted for detecting events from a set of user inputs, the events corresponding to input commands received from an input device and comprising an event description and an event coordinate representative of a position at which an event occurs; a time recorder module for recording and associating a time parameter to each detected event, the time parameter corresponding to a time span between detected events; and a text file creator adapted for creating a text file with a plurality of frame descriptions, each one of the frame descriptions corresponding to instructions for generating a frame of a video and comprising at least one detected event and an associated time parameter. A playing module comprises a frame extraction module adapted for retrieving the text file having the plurality of frame descriptions therein and extracting from each frame description the event and associated time parameter; and an image generator adapted for converting the event to an action triggered by a given event at a given event coordinate and applied to a given object present at the given event coordinate, and applying the action to a previous image to generate a new image and thereby provide a subsequent frame in the video.

The event detection module and text file creator of the recording module, and the frame extraction module and image generator of the playing module may be adapted to perform anyone of the method steps described herein. For example, the modules may be configured to retrieve objects or images remotely or locally, retrieve event descriptions and/or event identifiers remotely or locally, and apply actions using various sets of logical code. The event detection module and text file creator may be adapted to detect events, sub-events, event types, etc, and to retrieve identifiers for anyone of the detected elements. Similarly, the frame extraction module and image generator may be adapted to read identifiers of events, sub-events, event types, etc, and to retrieve descriptions therefore.

In this specification, the term “shapes” and “objects” are intended to refer to elements having predefined forms, such as geometric shapes (i.e. circles, squares, triangles, etc) and non-geometric shapes (i.e. hand-drawn forms), and/or to individual building blocks for creating elements of pre-defined forms, such as lines, curves, points, and any other element for use in creating geometric and non-geometric shapes.

### BRIEF DESCRIPTION OF THE DRAWINGS

Further features and advantages of the present invention will become apparent from the following detailed description, taken in combination with the appended drawings, in which:

FIG. 1 is a flowchart illustrating an exemplary method for providing low bandwidth videos over a network;

FIG. 2 is a flowchart illustrating an exemplary method for recording low bandwidth videos;

FIG. 3 is a flowchart illustrating an exemplary method for recording events to create low bandwidth videos;

FIG. 4 is a flowchart illustrating an exemplary method for creating a low bandwidth video file from the recorded events;

FIG. 5 is a flowchart illustrating an exemplary method for playing a low bandwidth video;

FIG. 6 is a flowchart illustrating an exemplary method for reading a low bandwidth video file;

FIG. 7 is a flowchart illustrating an exemplary method for displaying a low bandwidth video;

FIG. 8 is a screenshot of an exemplary initial frame before recording begins;

FIG. 9 is a screenshot of an exemplary final frame after recording ends;

FIG. 10 is a screenshot of an exemplary intermediary frame for frame 133 of 455 frames for the video recorded in FIG. 9;

FIG. 11 is a screenshot of an exemplary intermediary frame for frame 392 of 455 frames for the video recorded in FIG. 9;

FIG. 12 is a schematic of an exemplary system for recording, sending, receiving, and playing low bandwidth videos;

FIG. 13 is a block diagram of an video recorder/player from FIG. 12;

FIG. 14. is a block diagram of an exemplary application running on the video recorder/player of FIG. 13;

FIG. 15 is a block diagram of an exemplary recorder module from the application of FIG. 14;

FIG. 16 is a block diagram of an exemplary player module from the application of FIG. 14; and

FIG. 17 is a block diagram of an exemplary image generator from the player module of FIG. 16.

It will be noted that throughout the appended drawings, like features are identified by like reference numerals.

### DETAILED DESCRIPTION

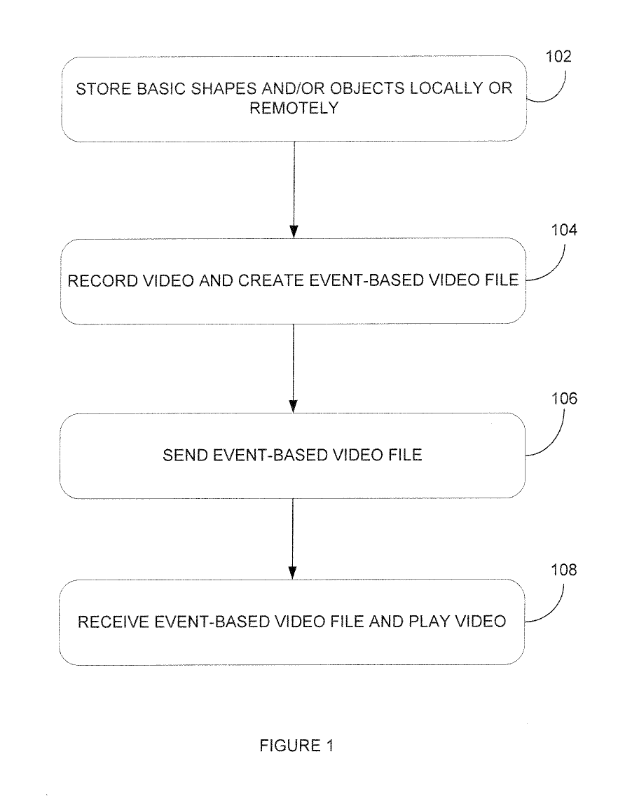

Referring to FIG. 1, there is illustrated an environment whereby event-based video files may be created, transmitted, and played. The video files are provided in an event-based format such that each frame of a video is represented using a minimal data set that corresponds to an event that has taken place during the frame. Events are detected and recorded and the video may then be reconstructed by identifying actions that are triggered by the recorded events and executing the actions accordingly. Actions are identified by matching an event and an event coordinate, considering the objects and/or shapes present in a frame at the event coordinate and determining the consequences of the event on the objects/shapes.

Table 1 illustrates some of the relationships used to reconstruct an event-based video, frame by frame.

TABLE 1

| | Object | | |
|---|---|---|---|
| | Location/ | Object/ | |
| Ojects | Size | SubObject ID | Actions |
| Cursor | x, y, w, h | ID1, ID2, ID3, etc. | Action1, Action2, Action3, |
| | | | etc. |
| Points | x, y, w, h | ID1, ID2, ID3, etc. | Action1, Action2, Action3, |
| | | | etc. |
| Lines | x, y, w, h | ID1, ID2, ID3, etc. | Action1, Action2, Action3, |
| | | | etc. |
| Segments | x, y, w, h | ID1, ID2, ID3, etc. | Action1, Action2, Action3, |
| | | | etc. |
| Rays | x, y, w, h | ID1, ID2, ID3, etc. | Action1, Action2, Action3, |
| | | | etc. |
| Circles | x, y, w, h | ID1, ID2, ID3, etc. | Action1, Action2, Action3, |
| | | | etc. |
| Oval | x, y, w, h | ID1, ID2, ID3, etc. | Action1, Action2, Action3, |
| | | | etc. |
| Rectangle | x, y, w, h | ID1, ID2, ID3, etc. | Action1, Action2, Action3, |
| | | | etc. |
| Pencil | x, y, w, h | ID1, ID2, ID3, etc. | Action1, Action2, Action3, |
| | | | etc. |
| Colors | x, y, w, h | ID1, ID2, ID3, etc. | Action1, Action2, Action3, |
| | | | etc. |
| Line Style | x, y, w, h | ID1, ID2, ID3, etc. | Action1, Action2, Action3, |
| | | | etc. |
| Text editer | x, y, w, h | ID1, ID2, ID3, etc. | Action1, Action2, Action3, |
| | | | etc. |
| Units | x, y, w, h | ID1, ID2, ID3, etc. | Action1, Action2, Action3, |
| | | | etc. |
| Decimals | x, y, w, h | ID1, ID2, ID3, etc. | Action1, Action2, Action3, |
| | | | etc. |
| Frame 1 | x, y, w, h | ID1, ID2, ID3, etc. | Action1, Action2, Action3, |
| | | | etc. |
| Frame 2 | x, y, w, h | ID1, ID2, ID3, etc. | Action1, Action2, Action3, |
| | | | etc. |
| etc. | x, y, w, h | ID1, ID2, ID3, etc. | Action1, Action2, Action3, |
| | | | etc. |

A sample list of objects is illustrated in the first column. For each object, its location/size and a unique identifier are associated thereto. Possible actions are also associated with each object. The action to be selected when reconstructing the video frame is chosen as a function of the event and the event coordinate found in the event-based video file, and the location of drawn objects, as will be explained in more detail below.

The videos may be composed of any images that may be produced using basic geometric shapes and/or objects, such as straight lines, curved lines, squares, circles, triangles, etc. For example, a house can be represented with a box for the base, a triangle for the roof, and rectangles for windows, doors, and a chimney. In an alternative embodiment, the images forming the videos may be composed of other types of predefined shapes and/or objects, such as cartoon animations and any type of hand-drawn shape. As per step 102, the shapes/objects may be stored locally or remotely from the device at which recording is performed.

In step 104, a video is recorded and an event-based video file is created. Recordation of a video may be performed from any known software products that allow editing and/or creation of an image. The video captures the editing/creation process in real-time. Each step of editing and/or image creation is reproduced as a frame in the video. For example, Adobe Photoshop™, Microsoft Paint™, and Microsoft Word™ are all programs that have an editing component whereby an image may be created and/or edited by a user. The user provides a set of commands to the program via an input device such as a mouse, a keyboard, and a touch screen to “draw” an image or modify an existing image. The video is recorded while various commands are input and applied to the image being edited. Once recorded, a text file is generated, as will be explained in more detail below. The event-based video file is sent over a network to a recipient at step 106. At step 108, the event-based video file is received and the video is played.

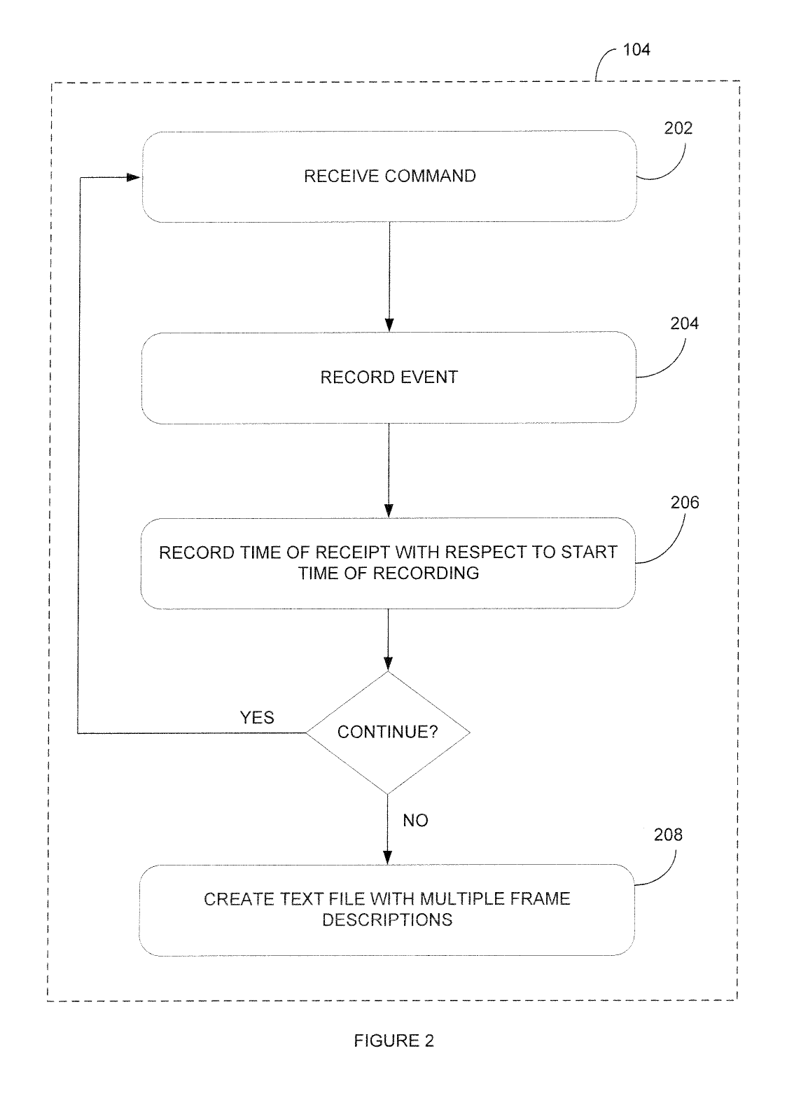

FIG. 2 illustrates in more detail an exemplary embodiment for recording the video and creating the event-based video file 104. In step 202, commands are received that correspond to the commands issued by the user as the image is being edited. Input commands contain information regarding what type of input is used, such as a mouse, a key, a touch, etc. This information is defined herein as an event type. The input commands also contain information regarding what is being done with the type of input, such as “mouse moved”, “mouse clicked”, “key pressed”, “key released”, etc. This information is defined herein as an event. Finally, the input commands contain information as to where on the screen or keyboard the event is occurring, such as “which key” or “mouse coordinates” or “touch coordinates”. This information is defined herein as an event coordinate. By combining an event type with an event and an event coordinate, it becomes possible to determine precisely what was done by the user such that it can be reproduced. All possible events and event types are stored locally or remotely and associated with an event identifier and an event type identifier, respectively. The events and event types may vary as a function of the editing program being used.

What has been done by the user during the event, or the resultant of the event, is defined herein as an action. Actions are triggered by events and are the consequences of an event on a given shape and/or object in an image. For example, when a cursor is positioned at a given position on a screen and the mouse button is depressed and released, an object found at the given position may have been selected. In this example, the event is the mouse click (pressed and released) and the action is the selection of the point. In another example, when a cursor is positioned at the given position on the screen and the mouse button is depressed and the mouse is moved downwards, this corresponds to a “drag” of an object found at the given position. Therefore, the event is “mouse pressed+mouse down+mouse released” and the action is “object selected and moved down”. At any given position on a screen, a given event will result in a given action. An action may be determined when an event and an accompanying event coordinate are known, based on the known coordinates of objects and/or shapes in an image.

Each command received is an indicator that an event has occurred and refers to the specific event. All of the information regarding the event is recorded at step 204. A time of receipt for the command is also recorded at step 206. This time stamp will allow the multiple frames making up the video to be properly set-out in time. Since a new frame is only generated when an event takes place, the display frequency of the frames may not be linear or periodic. As long as the video recorder is set to “record”, the method loops back to repeat steps 202, 204, and 206. When the video recorder is “paused” or “stopped”, recording stops and a text file is created with frame descriptions 208, as will be explained in more detail below.

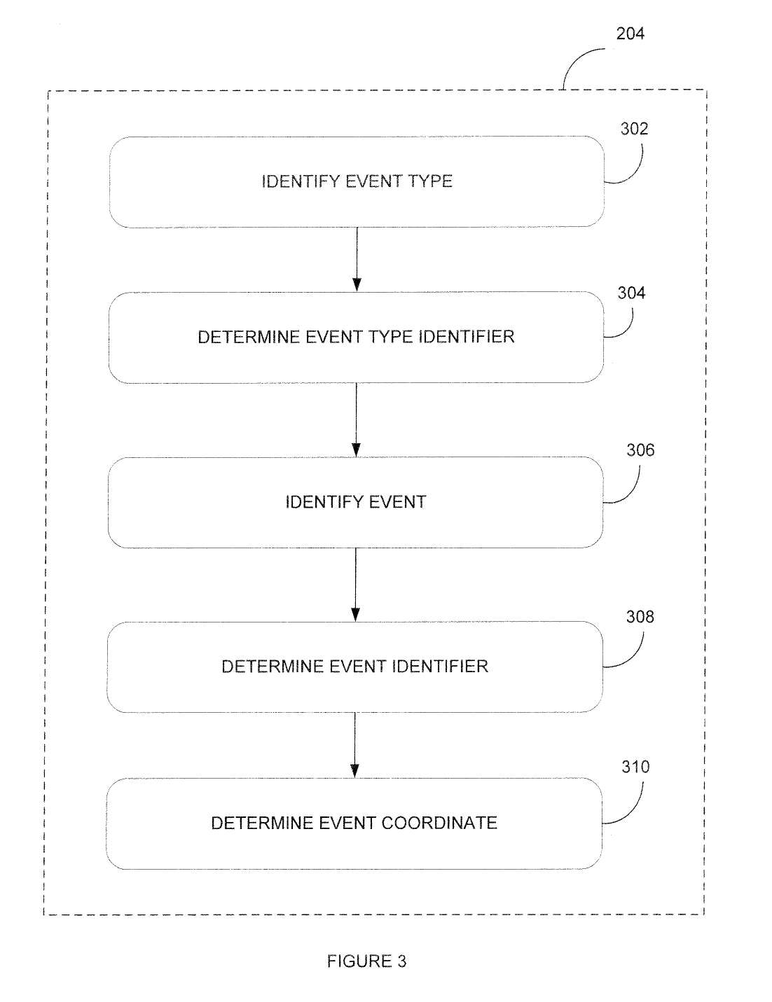

FIG. 3 illustrates in more detail an exemplary embodiment of step 204 for recording an event. In step 302, an event type is identified, i.e. there is a determination as to whether the input command came from a mouse, a keyboard, or a touch screen. In step 304, an event type identifier corresponding to the detected event type is retrieved. In step 306 an event is identified, i.e. there is a determination as to what event took place for the given event type. In step 308, an event identifier corresponding to the event is retrieved. In addition to the event type and the event, an event coordinate is determined in step 310.

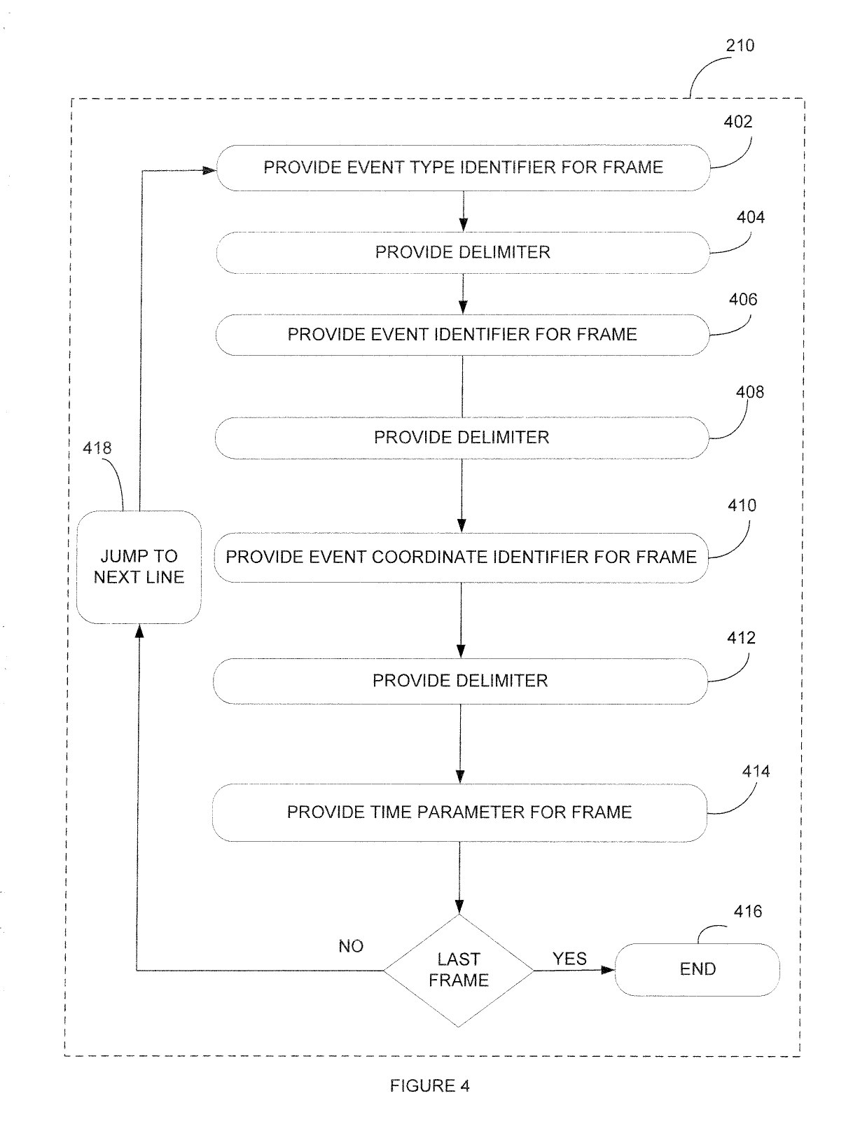

FIG. 4 illustrates in more detail an exemplary embodiment of the creation of an event-based video file, as per step 210 of FIG. 2. The event type identifier previously retrieved in step 304 is provided for a given frame 402. A delimiter, such as a colon, a semi-colon, a comma, etc, is inserted after the event type identifier in step 404, and the event identifier is provided at step 406. Another delimiter is inserted after the event identifier 408 and the event coordinate is provided at step 410. Another delimiter is inserted at step 412 to separate the event coordinate from a time parameter, which is provided at step 414. In this embodiment, the four components of the frame are provided on a single line. Before beginning the same process with steps 402 to 414 for a next frame, there may be a hard return executed in order to jump to a next line in the text file, as per step 416. Alternatively, another delimiter may be provided between frames. When the last frame has been recorded using the four components, the text file is complete and the process ends 418.

The reduced size video file (i.e. the text file created in step 210, is sent over any type of network using known transmission methods and technology. The only difference with a traditional video file as it is being sent to a destination is the overall size of the file and the file format.

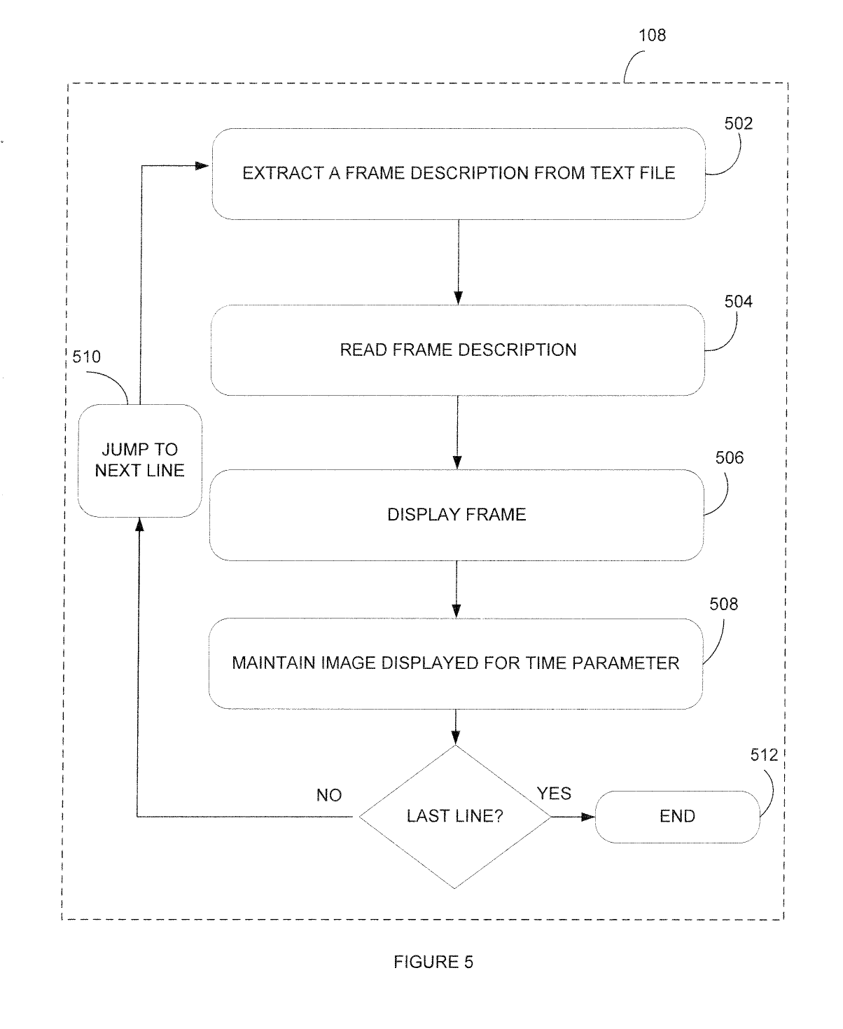

FIG. 5 illustrates in more detail an exemplary embodiment for receiving the event-based video file and playing the video, as per step 108 of FIG. 1. The procedure used to view the video may comprise a first step of extracting data from the text file, as per step 502. The frame description is read in step 504 and the frame is displayed in step 506. The image displayed for a given frame is maintained for a time corresponding to an extracted time parameter in step 508. Steps 502 to 508 may be repeated for each frame of the video. If the text file was created with each frame on a different line, then a jump to the next line is performed in step 510 before starting over. When all frames have been read and displayed, the video ends at step 514. It should be understood that while the flowchart of FIG. 5 illustrates extraction and display as a frame-by-frame process, all of the frame descriptions may be extracted in a single step and subsequently read one by one. Also alternatively, the frame descriptions may be extracted and read in a single step and displayed one by one.

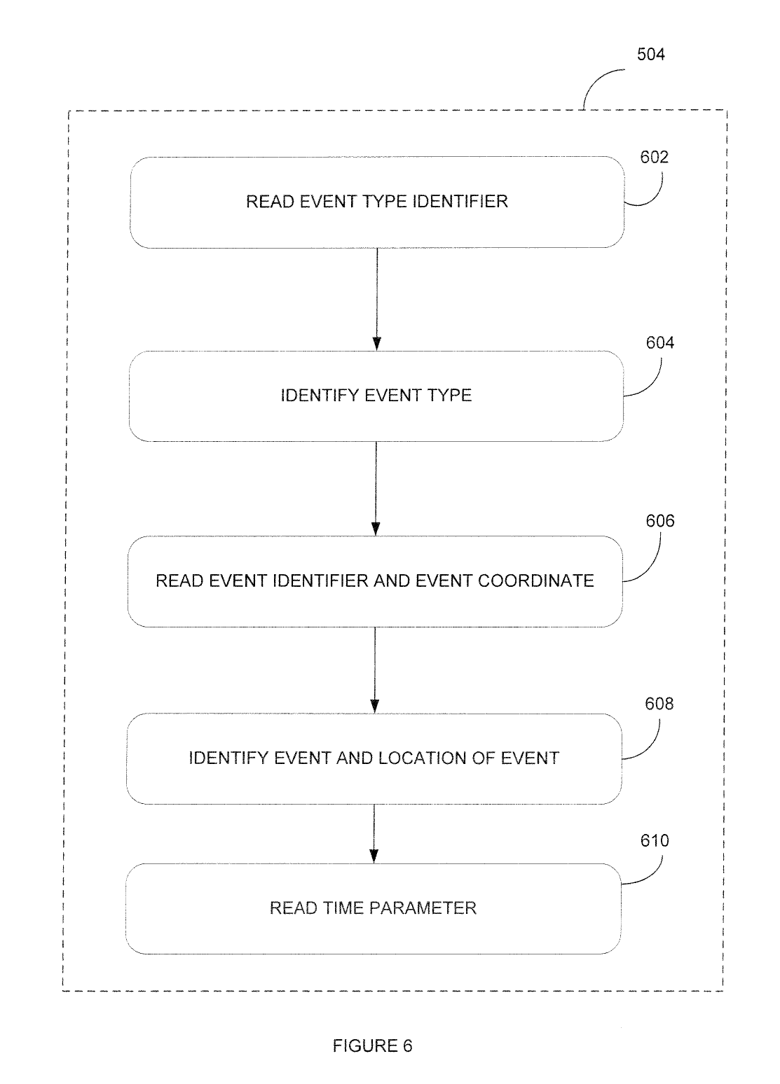

FIG. 6 illustrates in more detail an exemplary embodiment for reading a frame description, as per step 504 of FIG. 5. For each frame description, an event type identifier is read at step 602. From the event type identifier, the event type is determined, as per step 604. This determination is performed by accessing a local or remote storage of event types and corresponding event type identifiers. A similar procedure is performed for the event identifier and the event coordinate, which are both read at step 606. The event and its location are then identified at step 608. A time parameter for the frame is read at step 610.

When playing a video, the video begins by first displaying a start frame image. The start frame image corresponds to the starting point for the video. It may be a blank canvas or it may be an image having objects/shapes already positioned thereon. If the video is being played on the same device from which it was recorded, a starting image may be saved locally when the video begins recording and retrieved when the video begins playing. Alternatively, the event-based text file may comprise one or more frame descriptions that create the start frame image. Similarly, if the video is being played remotely on a device other than the one on which it was recorded, the start frame image may have been sent, in a traditional format or in the event-based format, and saved locally. The start based image is therefore retrieved when the video is played. Alternatively, the event-based text file may comprise one or more frame descriptions that create the start frame image when video playback begins. In this embodiment, all of the data needed to play the video is contained in the event-based text file, including the commands used to generate the start frame image.

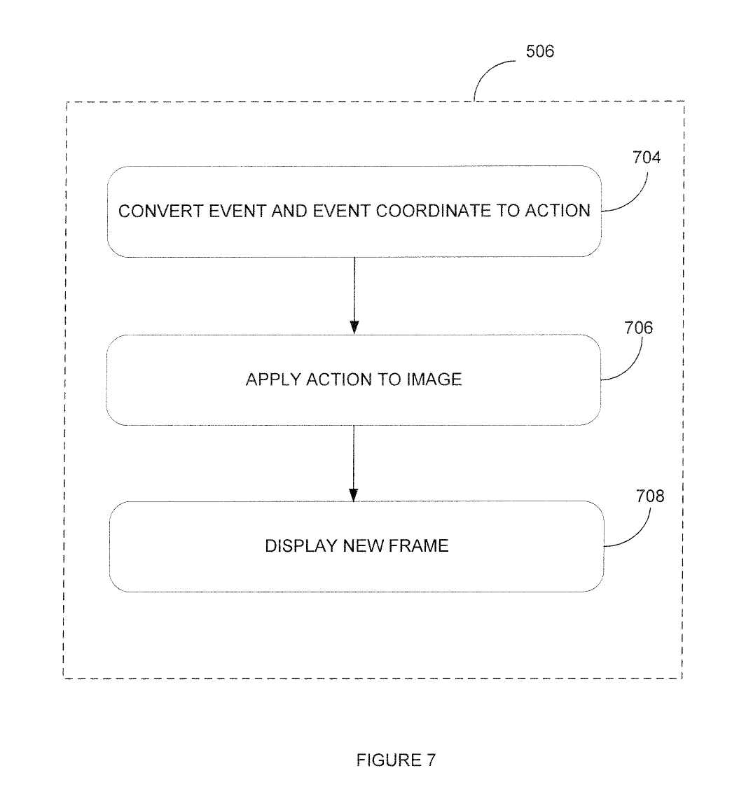

FIG. 7 illustrates a method for displaying a frame 506. Each event and corresponding event coordinate is converted to an action 704 to be applied to the start frame image or the previous frame. By applying the action to the image 706, the action that occurred on the original image as a result of the event is reproduced. For example, referring back to the previous example of an event corresponding to a cursor positioned on top of a point and the mouse button being pressed and released, the action reproduced is the selection of a point on the screen by the cursor. The action is determined based on the event, the event coordinate, and the known positions of the objects/shapes in the image. A new frame is displayed 708 when the action has been applied.

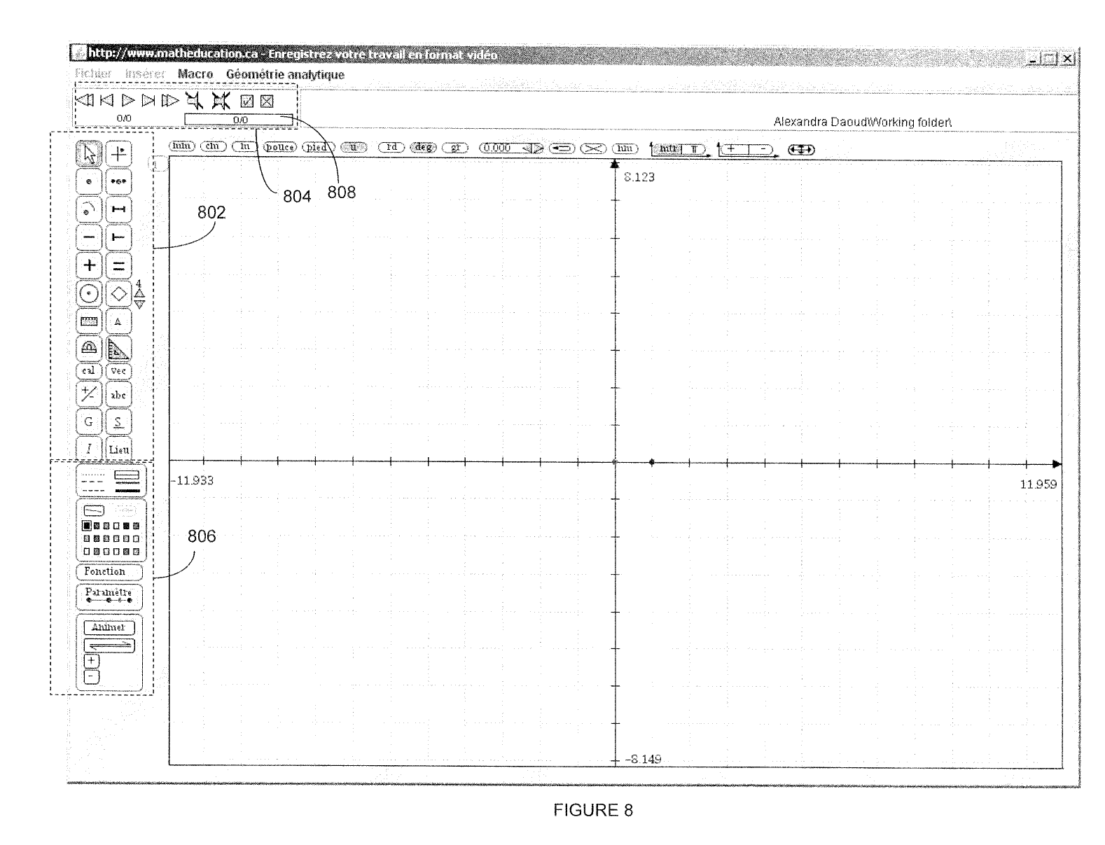

FIGS. 8 to 11 will now be referenced for a detailed example of the method applied to a mathematics drawing application. FIG. 8 illustrates a blank canvas for a mathematics drawing application. A user may use various drawing tools, such as those encompassed by box 802, to create a new drawing or edit an existing drawing. The drawing tools are used to place objects such as lines, segments, shapes, and points in the grid area. Additional functions are provided by the elements found in box 806, such as setting colors, animating objects on the screen, and modifying line parameters.

Recording functions are controlled by the items found in box 804, which allow the user to perform functions such as begin recording, pause recording, stop recording, forward a video, rewind a video, etc. Any functions that may be used for recording and/or viewing a video may be provided. Window 808 indicates a current frame and a total number of frames for a given video. Therefore when no video has been loaded and recording has not yet begun, window 808 indicates “0/0”.

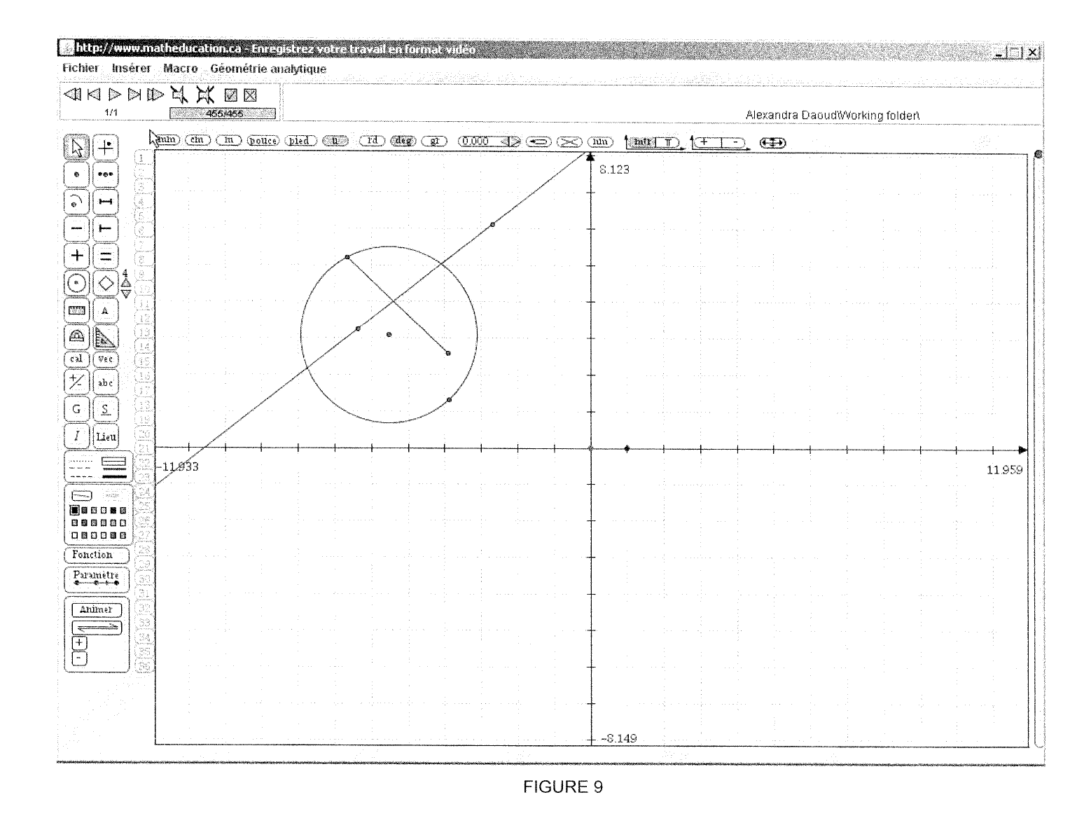

FIG. 9 illustrates the last frame of a video created by a user. As per window 808, the video contains 455 frames. As the video is played, each action taken by the user is displayed as if it were being performed in real-time. Some exemplary steps that were performed throughout this particular video recording are displacing the mouse from the grid to the circle function, selecting the circle function, drawing a circle, sizing the circle, moving the mouse to the line function, selecting the line function, drawing a line, positioning the line, etc. As each step is performed by the user, commands are received with information about each step. Each step may result in more than one event. For example, when drawing a line segment, concurring events of “mouse drag” and “draw line segment” occur. The steps of identifying an event type, identifying an event, and identifying an event coordinate are performed for each command received.

For the example illustrated, the frame description for frame #455 is as follows:
0|0|95|0|1313681233641

The first value of “0” is the identifier for the event type, which in this case is “Mouse” event type. The second value of “0” is the identifier for the event, which in this case is “Mouse move”. The third and fourth values, namely “95” and “0” correspond to the (x, y) coordinates of the position of the mouse on the screen. The last value is the time parameter represented as a binary number: “1313681233641”. Therefore, when the frame description is extracted from the text file and the event type identifier is read, the identifier “0” is searched for in a list of event types and corresponding event type identifiers. When event type identifier “0” is located, the corresponding event type of “Mouse” event is retrieved. This indicates that the second identifier, namely the event, corresponds to a “Mouse event” and a list of event identifiers for a “Mouse” event type is searched to locate identifier “0”, which corresponds to event “Mouse move”. With this information, combined with the event coordinate of (95, 0) and the time parameter, the image displayed for frame 455 is the same image displayed from frame 454 with the mouse cursor moved to coordinate (95, 0) on the screen. The displacement of the cursor therefore corresponds to the action applied to the previous frame.

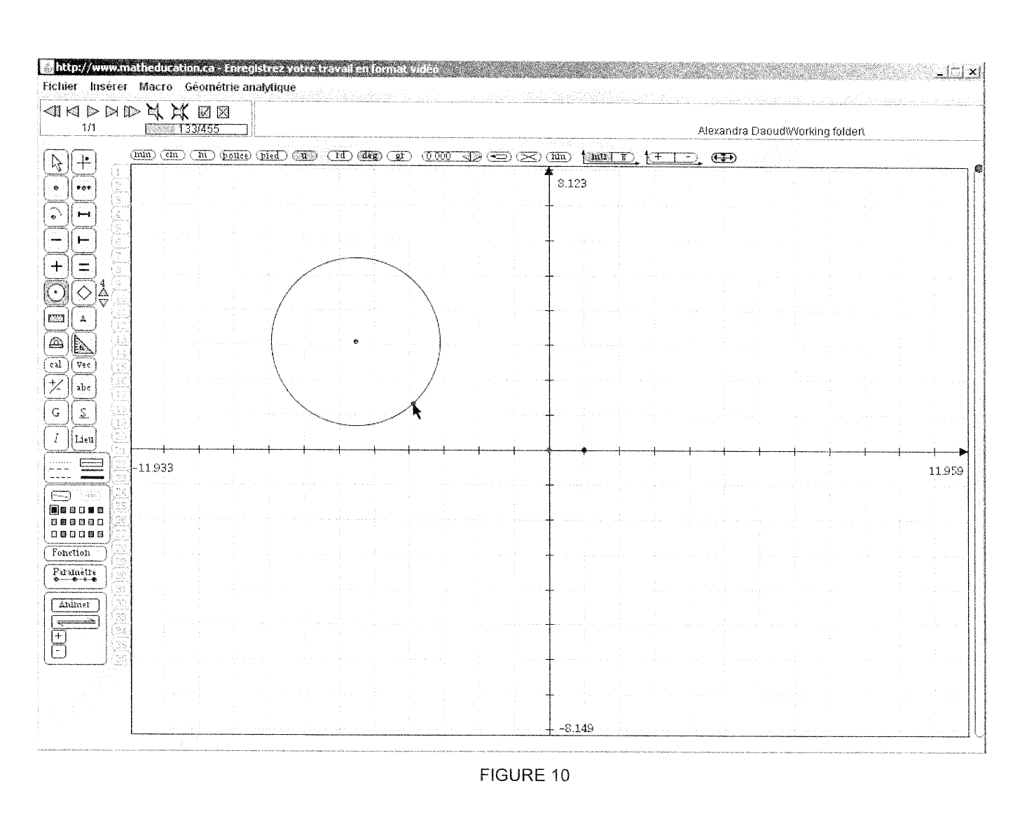

FIG. 10 illustrates frame 133 of 455 for the video recording of the present example. The frame description for this frame is as follows:

01241399128311313681221547

In this case, the event type identifier is again “0”, thereby corresponding to a “Mouse” event type, but the event identifier is “24”, which corresponds to “Mouse Move Select”. The event coordinate is (399, 283) and the time parameter is 1313681221547. The command that triggered the capture of this frame is the movement of the mouse while having the mouse key depressed.

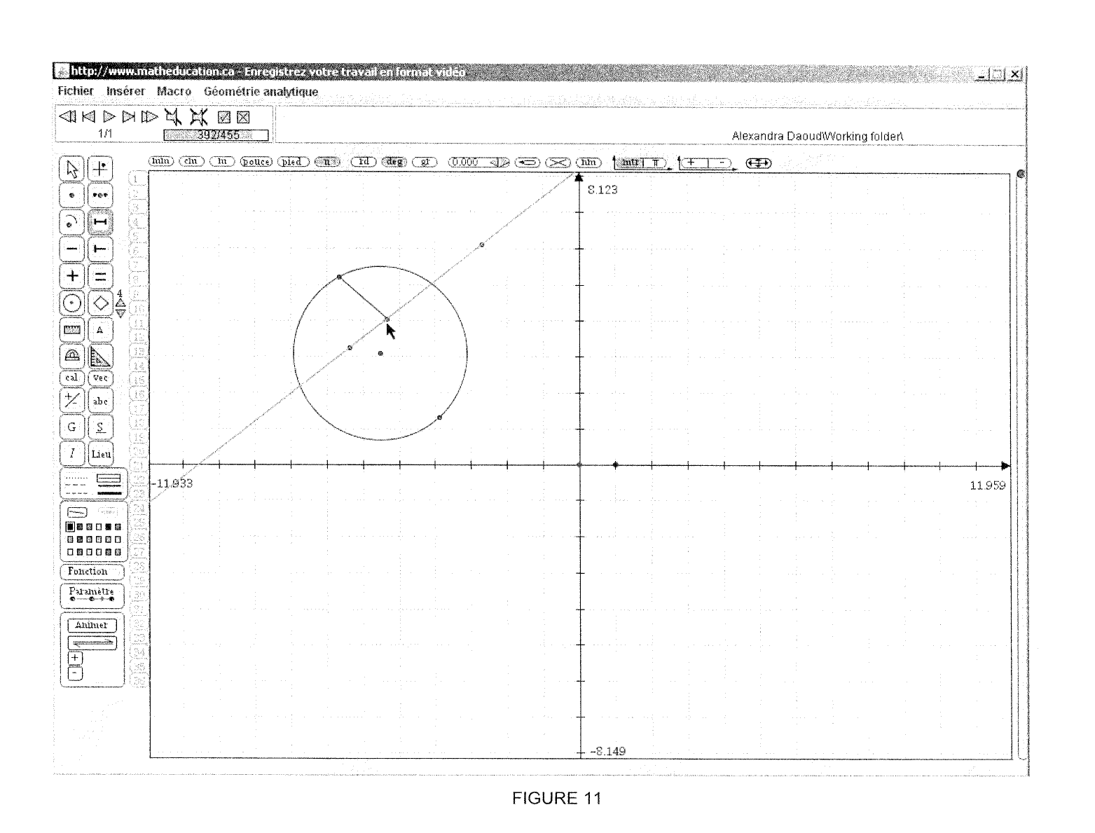

FIG. 11 illustrates frame 392 of 455 for the video recording of the present example. The frame description for this frame is as follows:
0|0|353|181|1313681230563

The event type identifier is again “0”, thereby corresponding to a “Mouse” event type, the event identifier is also “0”, which corresponds to “Mouse Move”. The event coordinate is (353, 181) and the time parameter is 1313681230563. The command that triggered the capture of this frame is the movement of the mouse.

A sample list of possible event types and their corresponding event type identifier is found below.

Mouse=“0”; // Mouse
Key = “1”; // Keyboard
Window = “2”; // Pop-up windows
Animate =“3”; // Animate objects
HSGO=“4”; // Hide-show-geometry objects
DMSq=“5”; // Mathematical function
nObj=“6”; // Name Object

A sample list of possible mouse events and their corresponding event identifiers is found below.

MM=“0”; // Mouse Move
MLD=“1”;// Mouse Left Down
MRD=“2”;// Mouse Right Down
MMD=“3”;// Mouse Mouse Dragged
MLU=“4”;// Mouse Left Up
MRU=“5”;// Mouse Right Up
MDd=“7”;// Mouse down dragged
MRd=“8”;// Mouse Right Down
MDC=“9”;// Mouse down Clicked
MMT=“12”; // Mouse Move Text
MLDT=“13”;// Mouse Left Down Text
MRDT=“14”;// Mouse Right Down Text
MLUT=“15”;// Mouse Left UP Text
MRUT=“16”;// Mouse Right Up Text
MDT=“17”;// Mouse down Text
MRT=“18”;// Mouse Right Text
MDCT=“19”;// Mouse Down Copy Text
MMC=“20”;// Mouse Move Calculator

A sample list of possible key events and their corresponding event identifiers is found below.

KDwn=“0”; // Key down
KUp=“1”;// Key Up
KPrsd=“2”;// Key Pressed
Esc=“3”;// // Key Escape
Dlt=“4”;// Key Delete
Char=“5”;// Key of Character (ex: a,b,c,d,e)
Ctr=“6”;// Key Control
M=“7”;// Key, M for Measurement
nLn=“8”; // Key Return for new line
Left=“9”;// Left arrow key
Right=“10”;// Right arrow Key
Up=“11”; // Up Key arrow
Down=“12”;// Down Key arrow
Back=“13”;// Back Key

It will be understood that the types of events and the events themselves may be different for each program using the present method. However, in order to play a video recorded by a given application, the corresponding event type and event listings are needed. In addition, additional components may be used to further define a frame. For example, in the image illustrated in FIG. 8, the grid may be separated into four quadrants and an additional identifier is provided to identify which quadrant the event is detected in. In another example, when a given function of the toolbar is activated, this may be used is a further identifier. In yet another example, the program may have different modes or operating states, such as draw, write, animate, etc. Each mode may be identified by a mode identifier in a frame description. While adding components to the frame description may increase the file size, it may help to reduce the complexity of the logic used to play a recorded video.

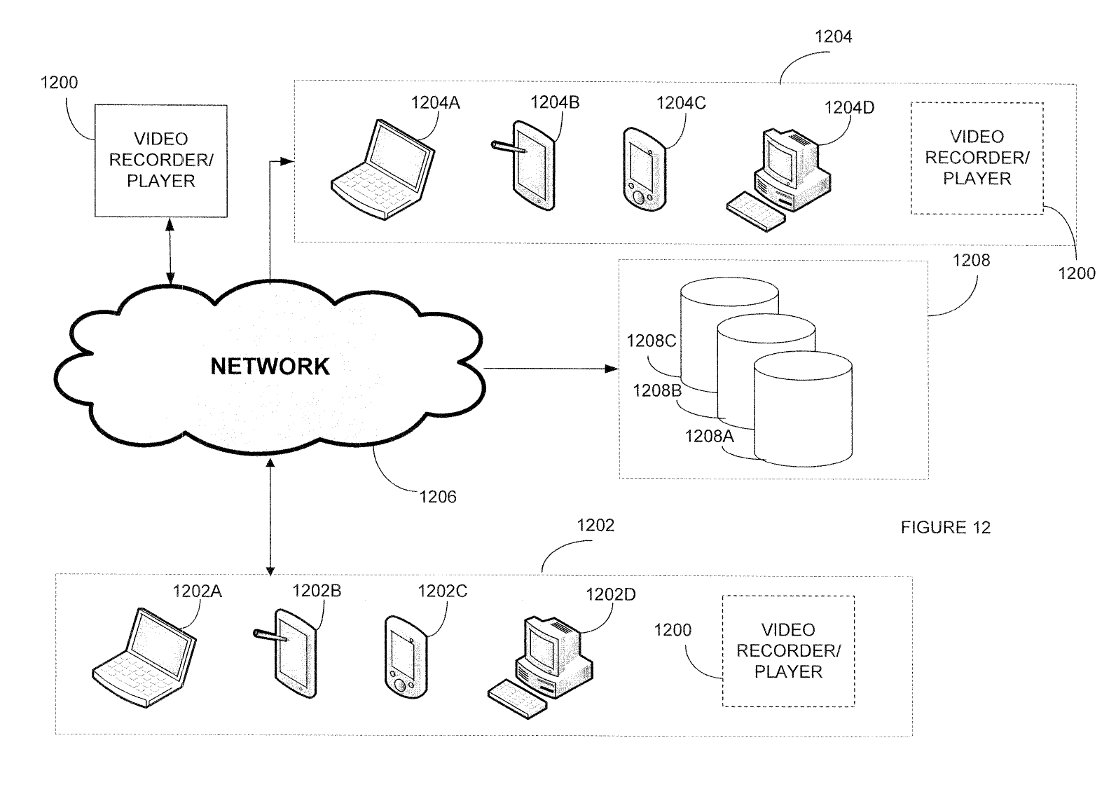

Referring now to FIG. 12, there is illustrated a system for recording, transmitting, receiving, and playing a reduced size video. At either end of a network 1206 are communication devices 1204, 1202, such as a laptop 1202a, 1204a, a tablet 1202b, 1204b, a mobile device 1202c, 1204c, and a desktop computer 1202d, 1204d. An event-based video recorder/player 1200 may be provided remotely via a network 1206 or it may be provided locally on each communication device 1202, 1204. In an alternative embodiment, the sender or receiver of the video may have the video recorder/player 1200 stored locally while the other of the sender or receiver may access the video recorder/player 1200 remotely. Similarly, one or more databases 1208a, 1208b, 1208c (referred to collectively as 1208) may be provided locally or remotely to the communication devices 1202, 1204 and/or to the video recorder/player 1200. The databases 1208 may be used to store the shapes/objects for generating the images in the videos. The network 1206 may be any type of network, such as the Internet, the Public Switch Telephone Network (PSTN), a cellular network, or others known to those skilled in the art.

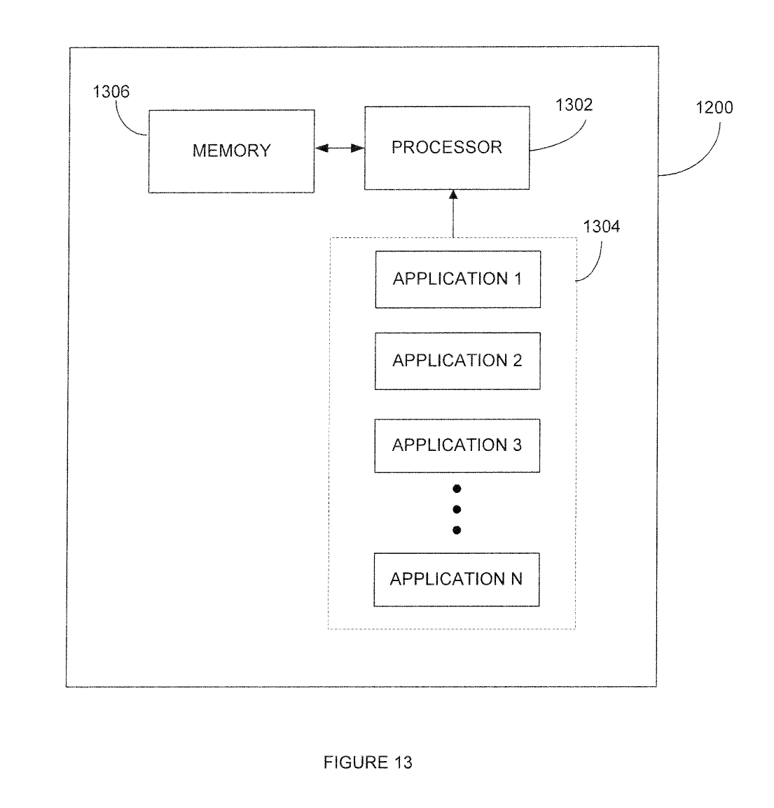

FIG. 13 illustrates the video recorder/player 1200 of FIG. 12 as a plurality of applications 1304 running on a processor 1302, the processor being coupled to a memory 1306. It should be understood that while the applications presented herein are illustrated and described as separate entities, they may be combined or separated in a variety of ways. The databases 1208 may be integrated directly into memory 1306 or may be provided separately therefrom and remotely from the video recorder/player 1200. In the case of a remote access to the databases 1208, access may occur via any type of network 1206, as indicated above. In one embodiment, the databases 1208 are secure web servers and Hypertext Transport Protocol Secure (HTTPS) capable of supported Transport Layer Security (TLS) is the protocol used for access to the data. Communications to and from the secure web servers may be secured using Secure Sockets Layer (SSL). An SSL session may be started by sending a request to the Web server with an HTTPS prefix in the URL, which causes port number 443 to be placed into packets. Port 443 is the number assigned to the SSL application on the server.

Alternatively, any known communication protocols that enable devices within a computer network to exchange information may be used. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol), POP3 (Post Office Protocol 3), SMTP (Simple Mail Transfer Protocol), IMAP (Internet Message Access Protocol), SOAP (Simple Object Access Protocol), PPP (Point-to-Point Protocol), RFB (Remote Frame buffer) Protocol.

The memory 1306 receives and stores data. The memory 1306 may be a main memory, such as a high speed Random Access Memory (RAM), or an auxiliary storage unit, such as a hard disk, a floppy disk, or a magnetic tape drive. The memory may be any other type of memory, such as a Read-Only Memory (ROM), or optical storage media such as a videodisc and a compact disc.

The processor 1302 may access the memory 1306 to retrieve data. The processor 1302 may be any device that can perform operations on data. Examples are a central processing unit (CPU), a front-end processor, a microprocessor, a graphics processing unit (GPU/VPU), a physics processing unit (PPU), a digital signal processor, and a network processor. The applications 1304 are coupled to the processor 1302 and configured to perform various tasks as explained above.

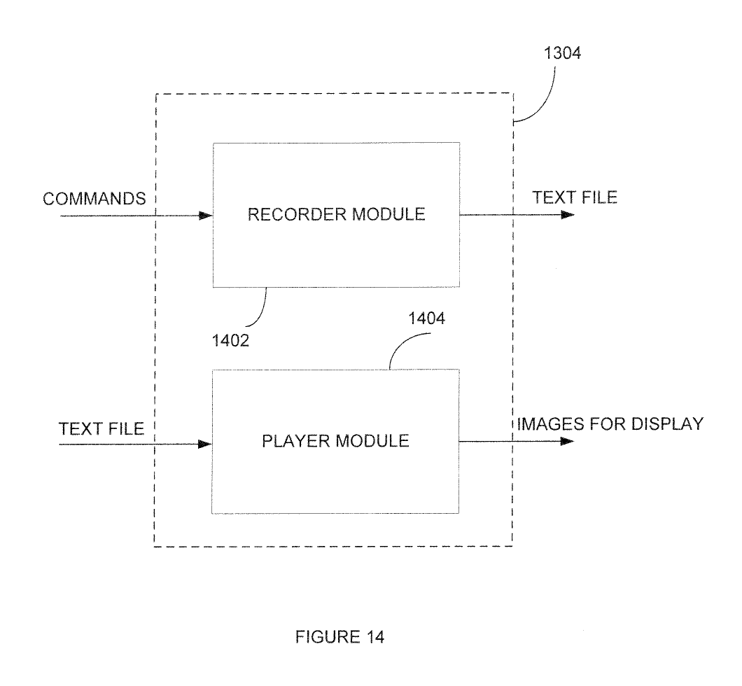

FIG. 14 is an exemplary embodiment of the application 1304 running on the processor 1302 of the video recorder/player 1200. In this embodiment, a recorder module 1402 and a player module 1404 are provided in the application 1304. In an alternative embodiment, the two modules 1402 and 1404 may be provided in separate applications. The recorder module 1402 receives as inputs commands issued by the user and outputs a text file for the event-based video file. The player module 1404 receives as input the text file and outputs a set of images for display as the video.

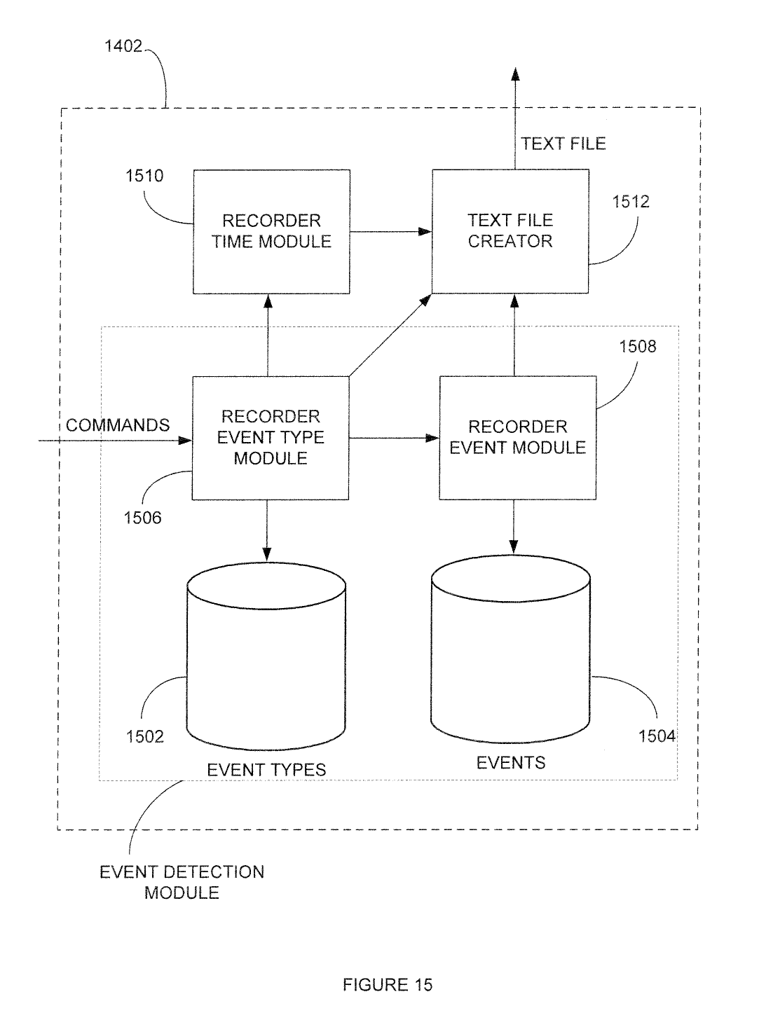

Referring to FIG. 15, there is illustrated an exemplary embodiment for the recorder module 1402. Commands are received at a recorder event type module 1506, which is configured to determine an event type and access an event type database 1502 to identify a corresponding event type identifier. The command and event type are passed on to a recorder event module 1508, which is configured to determine an event for the event type and access an event database 1504 to identify a corresponding event identifier. The recorder event module 1508 may also be configured to identify an event coordinate from the command. The command is also passed on to a recorder time module 1510 which records a time step for the command and generates a time parameter. The time parameter, event type identifier, event identifier, and event coordinate are sent to a text file creator 1512, which is configured to perform the steps of the method illustrated in FIG. 4. The output from the text file creator 1512 is the reduced size video file.

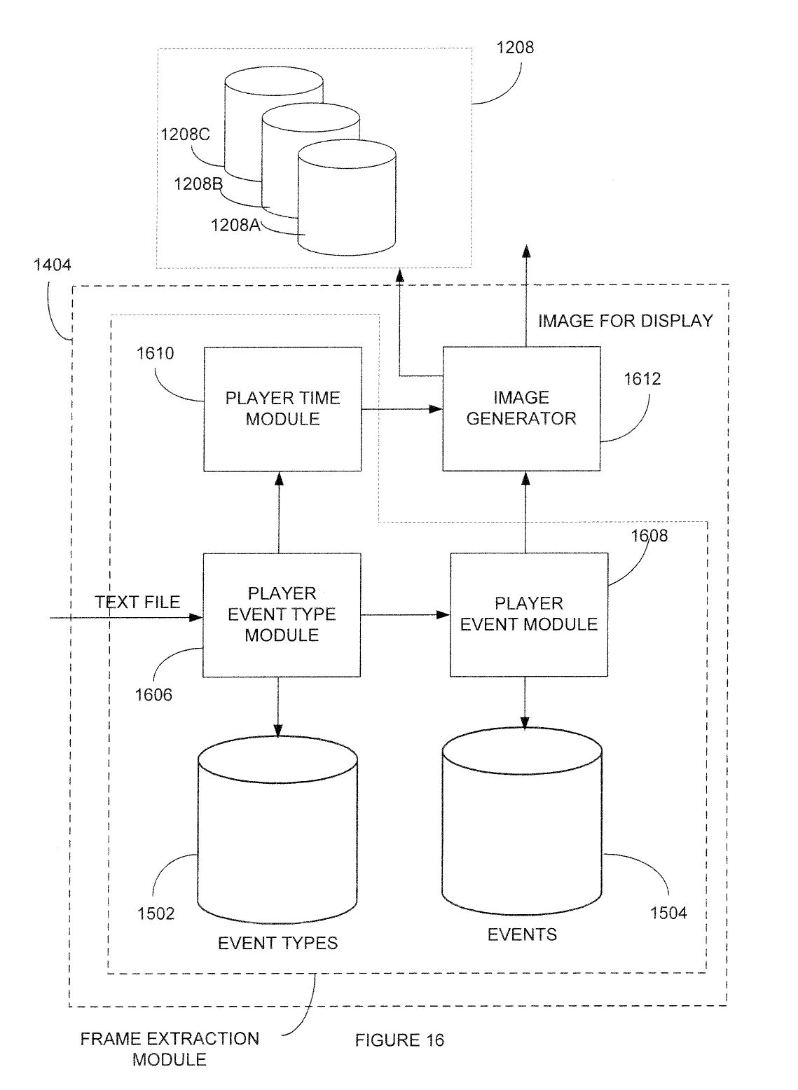

FIG. 16 illustrates an exemplary embodiment for the player module 1404. The text file created by the text file creator 1512 of the recorder module 1402 is received by the player module 1404 at a player event type module 1606. The player event type module is configured to read the event type identifiers from the frame descriptions and retrieve the corresponding event types from the event type database 1502. This information is transmitted to a player event module 1608 with the received text file. The player event module 1608 is configured to read the event identifier and knowing the event type, retrieve from the events database 1504 the corresponding event for the appropriate event type. The player event module 1608 may also be configured to read the event coordinate from the frame description. The player event type module 1606 is also configured to transmit the received text file to a player time module 1610 configured to read the time parameter. An image generator 1612 receives the event, the event coordinates, and the time parameter and generates a series of images that are sequentially displayed as the video.

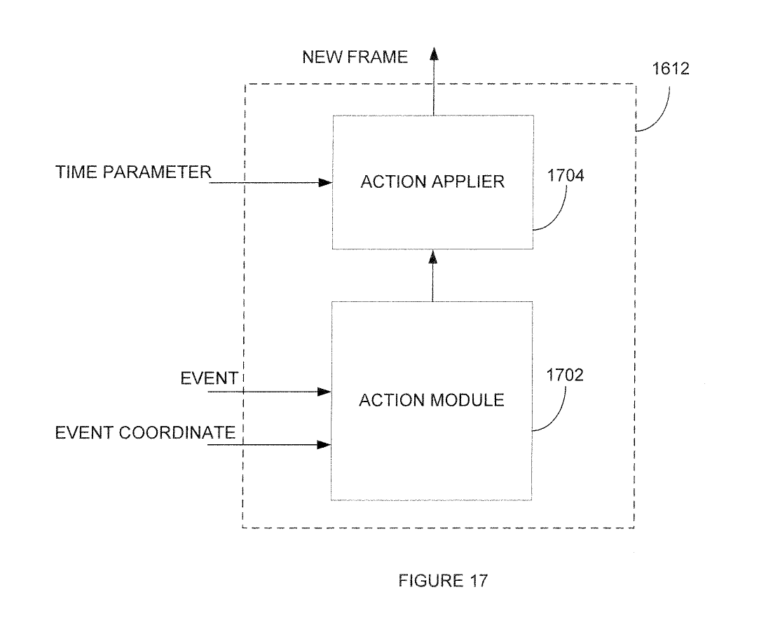

FIG. 17 illustrates an exemplary embodiment of the image generator 1612. Upon receipt of the event, the event coordinate, and the time parameter, an action module 1702 converts the event to an action, and an action applier 1704 applies the given action to the previous frame. In order to choose the appropriate action for the given event, a set of possible actions are provided to the action module 1702, each action being defined by an event and an event coordinate. Exemplary actions are as follows: select, type, drag, apply color, size object, apply font, draw line, draw segment, draw shape, display ruler, animate object, displace cursor, rotate object, etc. The list of possible actions may vary from one type of editing software to another. Each action may be represented by a set of logical code that executes a specific task, such as a routine, a function, a procedure, a subprogram, a sub-routine, etc. When the action module 1702 determines which action is to be performed, it instructs the action applier 1704 to run the appropriate set of logical code to execute the task corresponding to the action.

It will be understood by those skilled in the art that various modifications may be made to the implementation of the method described herein. Factors such as programming language, design choices, memory space, and processor speed may impact the actual implementation of the method without deviating from the scope of the present invention. For example, in one embodiment, the image generator 1612 accesses the databases 1208 to retrieve objects/shapes for generating the images. In an alternative embodiment, the objects/shapes are stored remotely. In some embodiments, a separate module is provided to determine the event coordinates for each frame. In some embodiments, the player event type module 1606 receives the text file and extracts all of the frame descriptions, and the frame descriptions are transmitted to the player time module 1610 and the player event module 1608. In other embodiments, the player event type module 1606 will only read the event type identifier and simply relay the entire text file to the player event module 1608 and the player time module 1610.

While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment.

It should be noted that the present invention can be carried out as a method, can be embodied in a system, a computer readable medium or an electrical or electro-magnetic signal. The embodiments of the invention described above are intended to be exemplary only. The scope of the invention is therefore intended to be limited solely by the scope of the appended claims.

1. A method for recording an event-based video, the method comprising:
detecting events from a set of user inputs, the events corresponding to input commands received from an input device and comprising an event description and an event coordinate representative of a position at which an event occurs;
associating a time parameter to each detected event, the time parameter corresponding to a time span between detected events; and
creating a text file with a plurality of frame descriptions, each one of the frame descriptions corresponding to instructions for generating a frame of the video and comprising at least one detected event and an associated time parameter, each event being convertible to an action triggered by a given event at a given event coordinate and applied to a given object present at the given event coordinate.

2. The method of claim 1, wherein detecting events comprises detecting an event type and detecting an event of the event type.

3. The method of claim 2, wherein detecting an event type comprises identifying the input device from which the input commands are received.

4. The method of claim 3, wherein the input device is selected from a group comprising a mouse, a keyboard, and a touch screen.

5. The method of claim 1, wherein creating a text file comprises retrieving an event identifier corresponding to the detected event and providing the event identifier, the event coordinate, and the time parameter in the frame description with a delimiter between each item.

6. A method for playing an event-based video, the method comprising:
receiving a text file having a plurality of frame descriptions therein, each one of the frame descriptions corresponding to instructions for generating a frame of the video and comprising at least one event and an associated time parameter, the event corresponding to an input command received from an input device and comprising an event description and an event coordinate representative of a position at which the event occurs, the time parameter representing a time span between subsequent events;
extracting from each frame description the event and associated time parameter;
converting the event to an action triggered by a given event at a given event coordinate and applied to a given object present at the given event coordinate; and
applying the action to a previous image to generate a new image and thereby provide a subsequent frame in the video.

7. The method of claim 6, wherein extracting from each frame description the event comprises reading an event identifier and retrieving an event description corresponding to the event identifier.

8. The method of claim 7, wherein reading an event identifier comprises reading an event type identifier and a corresponding event identifier, and retrieving the event description comprises retrieving an event type corresponding to the event type identifier and retrieving the event description for the corresponding event identifier of the event type.

9. The method of claim 6, wherein converting the event to an action comprises identifying an object at the event coordinate and retrieving the action from a list of predetermined actions associated to the object, whereby the event dictates which action is selected from the list of predetermined actions for the object.

10. The method of claim 6, wherein applying the action comprises applying the action in accordance with the time parameter such that no actions are applied in between the subsequent events and no new image is generated when no action is applied.

11. A method for recording and playing event-based videos, the method comprising:
while recording, detecting events from a set of user inputs, the events corresponding to input commands received from an input device and comprising an event description and an event coordinate representative of a position at which an event occurs;
associating a time parameter to each detected event, the time parameter corresponding to a time span between detected events;
creating and storing a text file with a plurality of frame descriptions, each one of the frame descriptions corresponding to instructions for generating a frame of the video and comprising at least one detected event and an associated time parameter;
to play the video, retrieving the text file with the plurality of frame descriptions;
extracting from each frame description the event and associated time parameter;
converting the event to an action triggered by a given event at a given event coordinate and applied to a given object present at the given event coordinate; and
applying the action to a previous image to generate a new image and thereby provide a subsequent frame in the video.

12. The method of claim 11, wherein detecting events comprises detecting an event type and detecting an event of the event type.

13. The method of claim 12, wherein detecting an event type comprises identifying the input device from which the input commands are received.

14. The method of claim 13, wherein the input device is selected from a group comprising a mouse, a keyboard, and a touch screen.

15. The method of claim 11, wherein creating and storing a text file comprises retrieving an event identifier corresponding to the detected event and providing the event identifier, the event coordinate, and the time parameter in the frame description with a delimiter between each item.

16. The method of claim 11, wherein extracting from each frame description the event comprises reading an event identifier and retrieving an event description corresponding to the event identifier.

17. The method of claim 16, wherein reading an event identifier comprises reading an event type identifier and a corresponding event identifier, and retrieving the event description comprises retrieving an event type corresponding to the event type identifier and retrieving the event description for the corresponding event identifier of the event type.

18. The method of claim 11, wherein converting the event to an action comprises identifying an object at the event coordinate and retrieving the action from a list of predetermined actions associated to the object, whereby the event dictates which action is selected from the list of predetermined actions for the object.

19. The method of claim 11, wherein applying the action comprises applying the action in accordance with the time parameter such that no actions are applied in between the subsequent events and no new image is generated when no action is applied.

20. The method of claim 11, further comprising recording the event-based videos on a first communication device, transmitting the text file over a communication medium to a second communication device remote from the first communication device, and playing the event-based videos on the second communication device.

21. The method of claim 11, wherein creating and storing the text file comprises adding at least one frame description to the text file with instructions for generating a start frame image of the video, and wherein the start frame image is generated when the video is played in a same manner as all other frames of the video.

22. The method of claim 11, further comprising retrieving a start frame image of the video and applying a first action thereto.

23. The method of claim 22, wherein retrieving a start frame image comprises retrieving the start frame image from a remote location.

24. The method of claim 20, further comprising transmitting an image file from the first communication device to the second communication device, the image file corresponding to a start frame image of the video, and wherein a first action of the video is applied to the start frame image.

25. The method of claim 24, wherein the image file is transmitted separately from the text file.
